(19) United States
(12) Patent Application Publication
(10) Pub. No.: US 2026/0229780 A1
(43) Pub. Date: Aug. 6, 2026

(54) ANTENNA STRUCTURE AND ELECTRONIC DEVICE

(71) Applicant: AUO Corporation, Hsinchu City (TW)

(72) Inventors: Chao-Yu Chen, Hsinchu City (TW); Shang-Yi Kuan, Hsinchu City (TW); Yu-Jung Liu, Hsinchu City (TW)

(21) Appl. No.: 19/448,717

(22) Filed: Jan. 14, 2026

(30) Foreign Application Priority Data
Jan. 24, 2025 (TW) 114103647

(51) Int. Cl. H01Q 9/04; H01Q 1/22; H01Q 1/50

(52) U.S. Cl. CPC H01Q 9/0407; H01Q 1/22; H01Q 1/50

(57) ABSTRACT

An antenna structure and an electronic device are provided. The antenna structure includes a substrate, an antenna structure layer, a feed line and a ground layer. The substrate has a surface. The antenna structure layer is disposed on the surface and has an edge. The feed line is disposed on the substrate and electrically connected to the antenna structure layer. The feed line has a feed point. The ground layer is disposed on the surface and has an inner edge. At least part of the antenna structure layer is surrounded by the inner edge. There is a shortest distance between the inner edge and the edge, and the shortest distance is between one and fifteen times the width of the feed line.

### CROSS - REFERENCE TO RELATED APPLICATION

This application claims priority to Taiwan Application Serial Number 114103647, filed January 24, 2025. The above-mentioned patent application is herein incorporated by reference in its entirety.

### BACKGROUND

### Technical Field

The present disclosure relates to an antenna structure and an electronic device.

### Description of the Related Art

Current methods for monitoring human physiological information have evolved to include the use of radar devices to detect human physiological information. For example, a radar device generates electromagnetic waves that partially reflect off the human body. The radar device receives the reflected electromagnetic waves and thus detects human physiological information (e.g., respiration, heartbeat, or determining whether a person is still in the same environment) based on the reflected electromagnetic waves.

However, radar devices are susceptible to interference from objects in the deployment environment, and therefore cannot accurately detect human physiological information. For example, rotating fans and fluttering curtains affect the detection accuracy of radar devices.

### SUMMARY

At least one embodiment of the present disclosure provides an antenna structure and an electronic device using the same.

The antenna structure provided in at least one embodiment of the present disclosure includes a substrate, an antenna structure layer, a feed line and a first ground layer. The substrate has a first surface. The antenna structure layer is disposed on the first surface and has an edge. The feed line is disposed on the substrate and electrically connected to the antenna structure layer. The feed line has a feed point. The first ground layer is disposed on the first surface and has an inner edge. At least part of the antenna structure layer is surrounded by the inner edge, and there is a shortest distance between the inner edge and the edge. The shortest distance is between one and fifteen times the width of the feed line.

In at least one embodiment of the present disclosure, the substrate further has a second surface opposite to the first surface. The antenna structure further comprises a second ground layer and a plurality of conductors. The second ground layer is disposed on the second surface. The conductors extend from the first ground layer to the second ground layer and are electrically connected to the first ground layer and the second ground layer. The conductors are spaced apart along the inner edge.

In at least one embodiment of the present disclosure, the substrate further has a second surface opposite to the first surface. The antenna structure further comprises a second ground layer and a plurality of conductors. The second ground layer is disposed in the substrate and located between the first surface and the second surface. The plurality of conductors extend from the first ground layer to the second ground layer and are electrically connected to the first ground layer and the second ground layer. The conductors are spaced apart along the inner edge.

In at least one embodiment of the present disclosure, a spacing between one of the conductors and the inner edge is less than 1 mm.

In at least one embodiment of the present disclosure, a spacing between two adjacent conductors is less than 2 mm.

In at least one embodiment of the present disclosure, the first ground layer further has an outer edge. The outer edge is farther from the antenna structure layer than the inner edge. The conductors are distributed between the inner edge and the outer edge. The number of the conductors decreases along a direction extending from the inner edge to the outer edge.

In at least one embodiment of the present disclosure, the first ground layer comprises a plurality of ground strips. The ground strips surround the antenna structure layer. Each of the ground strips has a width greater than 1 mm.

In at least one embodiment of the present disclosure, one of the ground strips has an opening.

An antenna structure provided in at least one embodiment of the present disclosure comprises a substrate, an antenna structure layer, a feed line, and a first ground layer. The substrate has a first surface. The antenna structure layer is disposed on the first surface and has an edge. The feed line is disposed on the substrate and electrically connected to the antenna structure layer. The feed line has a feed point. The first ground layer is disposed on the first surface. A plurality of strip-shaped gaps exist between the first ground layer and the edge. The strip-shaped gaps surround the antenna structure layer. The width of each of the strip-shaped gaps is 1 to 15 times the width of the feed line.

An electronic device provided in at least one embodiment of the present disclosure comprises the above-described antenna structure, a chip and a transmitter antenna. The chip is disposed on the substrate. The feed line is electrically connected between the chip and the antenna structure layer. The transmitter antenna is electrically connected to the chip.

Based on the above, in the antenna structure and the electronic device disclosed in the above embodiments, the first ground layer shields against interference from adjacent circuits or external environments, enabling the antenna structure to further concentrate the directionality of the radiation energy, thereby enhancing the signal-to-noise ratio.

### BRIEF DESCRIPTION OF THE DRAWINGS

To gain a more complete understanding of the embodiments and their advantages, reference is now made to the following description taken in conjunction with the accompanying drawings, in which:

FIG. 1 is a partial top view of an antenna structure according to at least one embodiment of the present disclosure;

FIG. 2 is a partial cross-sectional view taken along a section line I-I’ in FIG. 1;

FIG. 3 is a partial cross-sectional view of an antenna structure according to another embodiment;

FIG. 4 is a partial top view of an antenna structure according to yet another embodiment of the present disclosure;

FIG. 5 is a schematic comparison diagram of two-dimensional radiation patterns between the antenna structure of FIG. 4 and that of a comparative example; and

FIG. 6 is a block diagram of an electronic device according to at least one embodiment of the present disclosure.

### DETAILED DESCRIPTION

For clearly introducing the technical features of the present application below, the dimensions (such as length, width, thickness, and depth) of components (such as layers, membranes, substrates, and areas) in the figures will be scaled up disproportionately, and the number of some components will be reduced. Accordingly, the description and interpretation of the embodiments below shall not be limited to the number of components and the dimensions and shapes of the components shown in the figures, but shall encompass dimensions, shapes and deviations therebetween as a result of actual manufacturing processes and/or tolerances. For example, a flat surface shown in a figure may have a feature of roughness and/or nonlinearity, while an acute angle shown in a figure may be circular. Therefore, the components shown in the present application are mainly used for schematic purposes, and are not intended to accurately depict the actual shapes of the components, nor are they used to limit the claims of the patent application.

Secondly, the words “about”, “approximately” or “substantially” appearing herein encompass not only clearly recorded values and ranges of values, but also allowable deviation ranges understood by persons of ordinary skill in the art, in which the deviation ranges may be determined by errors resulting from measurements, and the errors are due, for example, to limitations of both a measuring system and process conditions. For example, two objects (such as a plane or a trace of a substrate) are “substantially parallel” or “substantially vertical”, where “substantially parallel” and “substantially vertical” respectively represent that the parallelism and perpendicularity between the two objects may contain non-parallelism and non-perpendicularity caused by the allowable deviation ranges.

In addition, the word “about” can mean within one or more standard deviations of the above values, such as ± 30%, ± 20%, ± 10% or ± 5%. The terms “about”, “approximately” or “substantially” and the like used in the present application may be used to select acceptable deviation ranges or standard deviations based on optical, etchable, mechanical or other properties, rather than a single standard deviation to apply all of the above optical, etchable, mechanical or other properties.

Spatially relative terms used in the present disclosure, such as “under”, “below”, “above”, “over”, are used to facilitate the description of a relative relationship between one component or feature and another component or feature, as shown in the figures. The real meaning of the spatially relative terms involves other orientations. For example, when turning upside down and downside up at 180 degrees, the relationship between one component and another may change from “under” and “below” to “above” and “over”. In addition, spatially relative statements used in the present disclosure shall be similarly interpreted.

In addition, the present disclosure may be implemented or applied by means of other different specific embodiments, the details of the present disclosure may be based on different viewpoints and applications, and various embodiments can be combined, modified and changed without deviating from the idea of the present disclosure. For clearly illustrating the following embodiments, components with identical or similar functions are designated by the same reference numerals.

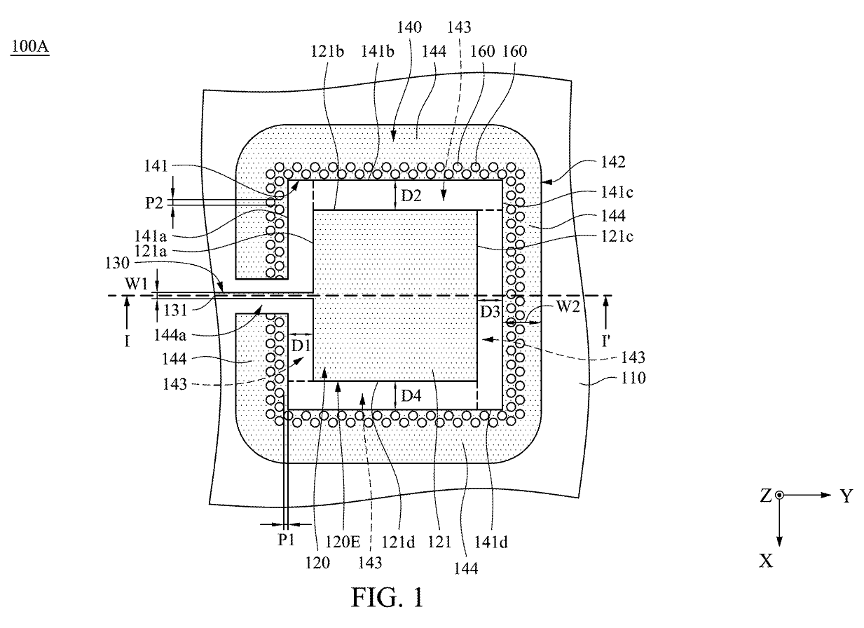

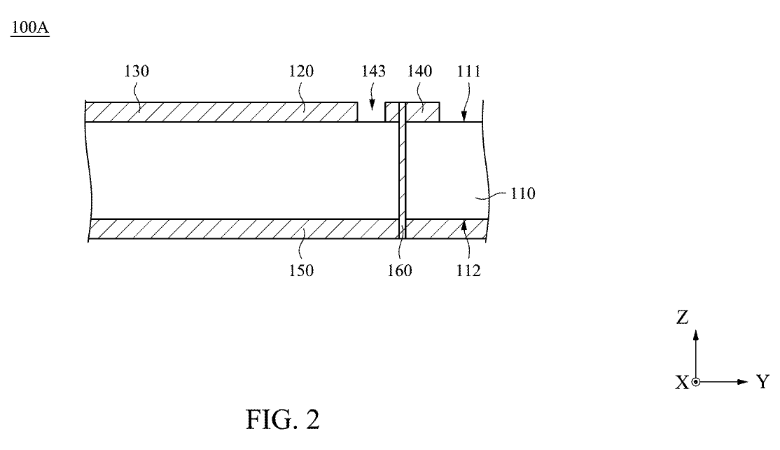

FIG. 1 is a partial top view of an antenna structure 100A according to at least one embodiment of the present disclosure, and FIG. 2 is a partial cross-sectional view taken along a section line I-I’ in FIG. 1. Referring to FIGS. 1 and 2, the antenna structure 100A can reduce power in side lobe directions to concentrate power in a main lobe direction. The antenna structure 100A includes a substrate 110, an antenna structure layer 120, a feed line 130, a first ground layer 140, a second ground layer 150 and a plurality of conductors 160.

The substrate 110 has a first surface 111 and a second surface 112 opposite to each other in a direction Z. In the example of FIG. 2, the antenna structure layer 120, the feed line 130, and the first ground layer 140 are disposed on the first surface 111 of the substrate 110, and the second ground layer 150 is disposed on the second surface 112 of the substrate 110. The substrate 110 is a double-layer board, that is, the substrate 110 may be formed by a dielectric layer with two metal layers respectively disposed on two surfaces of the dielectric layer, but is not limited thereto. In other embodiments, the substrate 110 may also be a three-layer board or a multilayer board with over three layers. In other words, the substrate 110 may be formed by a plurality of dielectric layers with a plurality of metal layers respectively disposed between the dielectric layers and on outer surfaces of two outermost dielectric layers.

The antenna structure layer 120 may be a metal plate, and includes a radiating portion 121. The radiating portion 121 may be substantially rectangular, but is not limited thereto. The radiating portion 121 has four outer edge lines 121a, 121b, 121c and 121d, where two outer edge lines 121a and 121c extend along a direction X (first direction) and the other two outer edge lines 121b and 121d extend along a direction Y (second direction). Therefore, an edge 120E of the antenna structure layer 120 may be formed by the four outer edge lines 121a, 121b, 121c and 121d of the radiating portion 121. In other embodiments, the shape of the radiating portion 121 may also be circular, rectangular, triangular, annular, or other polygonal.

The feed line 130 may be a metal trace and is electrically connected to the antenna structure layer 120. The feed line 130 may be a microstrip line configured to transmit feed signals to or from the antenna structure layer 120. The shape of feed line 130 is substantially rectangular and extends along the direction Y. The feed line 130 has a feed point 131. The feed point 131 is located at an end of the feed line 130 away from the antenna structure layer 120. The feed point 131 may be electrically connected to a chip (not shown in FIG. 1), such as a radio frequency integrated circuit (RFIC) or a monolithic microwave integrated circuit (MMIC). A width W1 of the feed line 130 can be adjusted according to variations in a thickness of the substrate 110, a dielectric constant of the substrate 110, or an operating frequency of the antenna structure 100A. By adjusting the width W1 of the feed line 130, impedance matching between the feed line 130 and the antenna structure layer 120 can be achieved.

For example, the feed line 130 may be electrically connected between the antenna structure 100A and an impedance matching circuit, and the impedance matching circuit is electrically connected between the chip and the feed line 130. Therefore, by adjusting the width W1 of the feed line 130, impedance matching can be achieved between the feed line 130 and both the antenna structure layer 120 and the impedance matching circuit.

The first ground layer 140 may be a metal plate and is spaced apart from the antenna structure layer 120. The first ground layer 140 has an inner edge 141 adjacent to the antenna structure layer 120 and an outer edge 142 away from the antenna structure layer 120. At least part of the antenna structure layer 120 is surrounded by the inner edge 141. For example of FIG. 1, the shape of the inner edge 141 of the first ground layer 140 is substantially rectangular and the inner edge 141 surrounds the outer edge lines 121b, 121c, 121d and part of the outer edge line 121a of the radiating portion 121. The inner edge 141 has a first edge segment 141a, a second edge segment 141b, a third edge segment 141c and a fourth edge segment 141d, where the first edge segment 141a and the third edge segment 141c extend along the direction X, and the second edge segment 141b and the fourth edge segment 141d extend along the direction Y. The first edge segment 141a, the second edge segment 141b, the third edge segment 141c, and the fourth edge segment 141d are parallel to the outer edge lines 121a, 121b, 121c, and 121d, respectively.

Specifically, a distance D1 between the first edge segment 141a and the outer edge line 121a, a distance D2 between the second edge segment 141b and the outer edge line 121b, a distance D3 between the third edge segment 141c and the outer edge line 121c, and a distance D4 between the fourth edge segment 141d and the outer edge line 121d are all between one and fifteen times the width W1 of the feed line 130.

It should be noted that the distances D1, D2, D3, and D4 may be all identical, all different, or partially identical. In other words, the distances D1, D2, D3, and D4 may be adjusted according to the area of the first surface 111 of the substrate 110 or the positions of the antenna structure layer 120 and the first ground layer 140, and are not limited to being identical. Additionally, since in the example of FIG. 1, the first edge segment 141a, the second edge segment 141b, the third edge segment 141c, and the fourth edge segment 141d are parallel to the outer edge lines 121a, 121b, 121c, and 121d, respectively, a shortest distance among the distances D1, D2, D3, and D4 is also a shortest distance between the inner edge 141 of the first ground layer 140 and the edge 120E of the antenna structure layer 120, which is also between one and fifteen times the width W1 of the feed line 130. In other embodiments, the inner edge 141 of the first ground layer 140 is not parallel to, or only partially parallel to, the outer edge lines of the radiating portion 121. For example, the outer edge lines of the radiating portion 121 extend only along the direction X, or only along the direction Y, or neither along the direction X nor along the direction Y. It should be noted that a shortest distance from any point on the inner edge 141 to the outer edge lines of the radiating portion 121 is also between one and fifteen times the width W1 of the feed line 130.

On the other hand, the first ground layer 140 surrounding part of the antenna structure layer 120 and spaced apart from the antenna structure layer 120 may also be interpreted as: a plurality of strip-shaped gaps 143 exist between the inner edge 141 of the first ground layer 140 and the edge 120E of the antenna structure layer 120, and the strip-shaped gaps 143 surround the antenna structure layer 120 in a frame-shaped arrangement. For example of FIG. 1, the strip-shaped gaps 143 form a rectangular frame to surround the antenna structure layer 120, and the distances D1, D2, D3, and D4 are respectively the widths of the strip-shaped gaps 143. Therefore, the widths of the strip-shaped gaps 143 may be all identical, all different, or partially identical, without limitation. In other embodiments, the strip-shaped gaps 143 may form frames of other shapes to surround the antenna structure layer 120, without limitation.

Further, the first ground layer 140 includes a plurality of ground strips 144. The ground strips 144 are connected in series and surround the antenna structure layer 120, and the ground strips 144 also surround the antenna structure layer 120 in a frame-shaped arrangement. For example of FIG. 1, the ground strips 144 form a substantially rectangular frame to surround the plurality of strip-shaped gaps 143 and the antenna structure layer 120. One of the ground strips 144 may have an opening 144a, allowing the feed line 130 to extend beyond the ground strip 144 through the opening 144a to be electrically connected to the chip or the circuit. A width W2 of each ground strip 144 may be greater than 1millimeter. Additionally, the widths W2 of the ground strips 144 may be all identical, all different, or partially identical, without limitation.

The second ground layer 150 may be a metal plate. A vertical projection area (projection area in the direction Z) of the second ground layer 150 at least partially overlaps with vertical projection areas of the antenna structure layer 120, the first ground layer 140 and the feed line 130. The plurality of conductors 160 extend from the first ground layer 140 to the second ground layer 150 and are electrically connected to the first ground layer 140 and the second ground layer 150. The plurality of conductors 160 are distributed between the inner edge 141 and the outer edge 142. In particular, the conductors 160 are spaced apart and arranged along the inner edge 141 of the first ground layer 140. The conductors 160 surround the strip-shaped gaps 143. The conductors 160 may densely surround the inner edge 141 in at least two rows. Thus, via the conductors 160, effective electrical conduction between the first ground layer 140 and the second ground layer 150 can be achieved. Since the conductors 160 densely surround the inner edge 141, the overall ground area of the first ground layer 140 and the second ground layer 150 is increased, thereby achieving better noise absorption. Moreover, the closer the conductors 160 are to the inner edge 141, the more effectively they absorb noise affecting the antenna structure layer 120.

For example, the antenna structure 100A may operate in the 24 GHz band. A spacing P1 between some conductors 160 (e.g., a row of the conductors 160 closest to the inner edge 141 and surrounding the inner edge 141) and the inner edge 141 may be greater than 0 mm and less than 1 mm, and a spacing P2 between two adjacent conductors 160 of the conductors 160 may be greater than 0 mm and less than 2 mm.

In other embodiments, some conductors 160 are farther from the inner edge 141 and also surround the inner edge 141, and a distance between two adjacent conductors 160 of the conductors 160 may be greater than 2 mm. That is, the conductors 160 closer to the inner edge 141 may be arranged more densely, while those farther from the inner edge 141 may be arranged more sparsely. The number and density of the conductors 160 decrease along a direction extending from the inner edge 141 to the outer edge 142. The conductors 160 farther from the inner edge 141 may also increase the overall ground area of the first ground layer 140 and the second ground layer 150 and simplify manufacturing complexity.

As a result of the above, since the first ground layer 140 surrounds part of the antenna structure layer 120 and is spaced at an appropriate distance from the antenna structure layer 120, interference from other chips, circuits on the same substrate 110, or external environments to the antenna structure layer 120 can be reduced, and the first ground layer 140 does not affect the operation of the antenna structure layer 120. This enables the antenna structure 100A to further concentrate the directionality of the radiation energy, thereby enhancing the signal-to-noise ratio. Additionally, by electrically connecting the conductors 160 to the first ground layer 140 and the second ground layer 150, the first ground layer 140 may achieve better noise absorption.

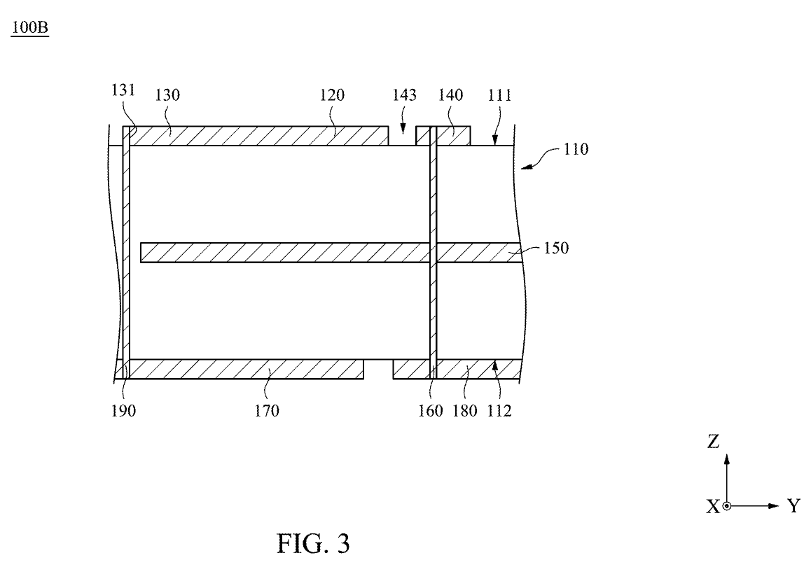

FIG. 3 is a partial cross-sectional view of an antenna structure 100B according to another embodiment. Referring to FIGS. 1 and 3, the antenna structure 100B of FIG. 3 is similar to the antenna structure 100A of FIG. 1, where a top view of the antenna structure 100B may be similar to that shown in FIG. 1. A difference between the two lies in that a substrate 110 of the antenna structure 100B is a three-layer board, and a second ground layer 150 is disposed in the substrate 110 and located between a first surface 111 and a second surface 112. The antenna structure 100B further includes a circuit layer 170, a third ground layer 180, and a feed element 190. The circuit layer 170 and the third ground layer 180 are disposed on the second surface 112 and are spaced apart from each other. The feed element 190 extends from a feed line 130 to the circuit layer 170 and is electrically connected to a feed point 131 and the circuit layer 170. Additionally, conductors 160 are electrically connected to a first ground layer 140, the second ground layer 150 and the third ground layer 180.

The antenna structure 100B may be applied to an electronic device in which a chip (not shown in FIG. 3) and an antenna structure layer 120 are on different planes. For example, if the antenna structure layer 120 is on the first surface 111 and the chip is on the second surface 112, a feed signal can be transmitted between the chip and the antenna structure layer 120 via the feed element 190 and the feed line 130. In other embodiments, the feed line 130 and the chip may be disposed on the second surface 112; that is, the feed line 130 and the chip are both on a different plane from the antenna structure layer 120, and the feed element 190 is electrically connected between the feed line 130 and the antenna structure layer 120. As such, a ground strip 144 may not have the opening 144a for the feed line 130 to pass through, and the first ground layer 140 may completely surround the antenna structure layer 120.

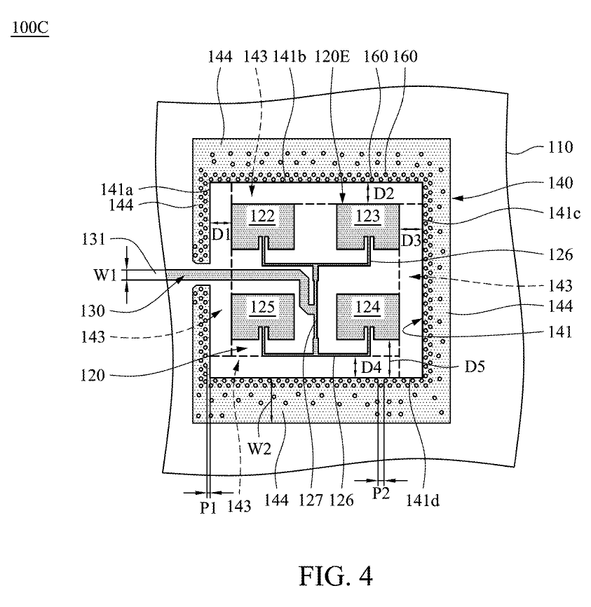

FIG. 4 is a partial top view of an antenna structure 100C according to yet another embodiment of the present disclosure. Referring to FIG. 4, the antenna structure 100C of FIG. 4 is similar to the antenna structure 100A of FIG. 1. A difference is that an antenna structure layer 120 of the antenna structure 100C includes a plurality of radiating portions 122, 123, 124, 125, a plurality of first trace portions 126 and a second trace portion 127. Each of the first trace portions 126 connects two of the radiating portions 122, 123, 124, and 125. The second trace portion 127 connects two first trace portions 126. Therefore, an edge 120E of the antenna structure layer 120 is an outer edge line formed by the radiating portions 122, 123, 124, 125, the first trace portions 126, and the second trace portion 127. A feed line 130 is electrically connected to the second trace portion 127. The feed line 130 maintains a uniform width W1 except at bent portions.

It should be noted that each of the antenna structure layers 120 of the antenna structures 100A and 100B is a single patch antenna, while the antenna structure layer 120 of the antenna structure 100C is a 2X2 patch antenna array, but the present disclosure is not limited thereto. In other embodiments, the antenna structure layer 120 may be a 2ⁿX2ⁿ patch antenna array (n is an integer greater than 1), an MXN patch antenna array, or an MXN series-fed patch antenna array (M and N are integers). Therefore, the numbers and configurations of the radiating portions 122, 123, 124, 125, the first trace portions 126, and the second trace portion 127 of the antenna structure layer 120 can be adjusted according to different patch antenna arrays. In other embodiments, the antenna structure layer 120 may not have the second trace portion 127, or the antenna structure layer 120 may further include a third trace portion (not shown) that are electrically connected to two second trace portions 127. In other embodiments, the antenna structure layer 120 may also be an antenna used for near field communication (NFC). Consequently, the edge 120E of the antenna structure layer 120 also varies according to the different shapes and structures of the antenna structure layer 120.

In FIG. 4, a first edge segment 141a, a second edge segment 141b, and a third edge segment 141c of an inner edge 141 of a first ground layer 140 are closer to the radiating portions 122, 123, 124, and 125. A fourth edge segment 141d is closer to one of the first trace portions 126. That is, between the first edge segment 141a and the radiating portion 122, or between the first edge segment 141a and the radiating portion 125, there is a strip-shaped gap 143 having a width of distance D1. Between the second edge segment 141b and the radiating portion 122, or between the second edge segment 141b and the radiating portion 123, there is a strip-shaped gap 143 having a width of distance D2. Between the third edge segment 141c and the radiating portion 123, or between the third edge segment 141c and the radiating portion 124, there is a strip-shaped gap 143 having a width of distance D3. Between the fourth edge segment 141d and one of the first trace portions 126, there is a strip-shaped gap 143 having a width of distance D4. The strip-shaped gaps 143 also surround the antenna structure layer 120, and the distances D1, D2, D3, and D4 are all between one and fifteen times the width W1 of the feed line 130. Furthermore, between the fourth edge segment 141d and the radiating portion 124, or between the fourth edge segment 141d and the radiating portion 125, there is also a gap having a width of a distance D5, which is between two and sixteen times the width W1 of the feed line 130.

Additionally, each of the widths W2 of a plurality of ground strips 144 surrounding the plurality of strip-shaped gaps 143 and the antenna structure layer 120 is greater than 1 millimeter. A spacing P1 between some conductors 160 and the inner edge 141 is also greater than 0 millimeter (mm) and less than 1 mm, and a spacing P2 between two adjacent conductors 160 of the conductors 160 is also greater than 0 mm and less than 2 mm.

Moreover, electromagnetic simulations are conducted at 15 times, 1 time and 0.5 times the width W1 for the distances D1, D2, D3, and D4 between the inner edge 141 of the first ground layer 140 and the antenna structure layer 120. The antenna structure 100C has gains of 9.772 dBi, 9.770 dBi, and 9.637 dBi at 24.1 GHz, where dBi denotes decibels relative to an isotropic antenna. It can thus be seen that when the distances D1, D2, D3, and D4 are 15 times or 1 time the width W1, the gain of the antenna structure 100C exhibits no significant degradation. However, when the distances D1, D2, D3, and D4 are 0.5 times the width W1, the gain of the antenna structure 100C decreases. Therefore, if the first ground layer 140 is too close to the antenna structure layer 120, the first ground layer 140 will affect the gain of the antenna structure 100C and disrupt the operation of the antenna structure 100C.

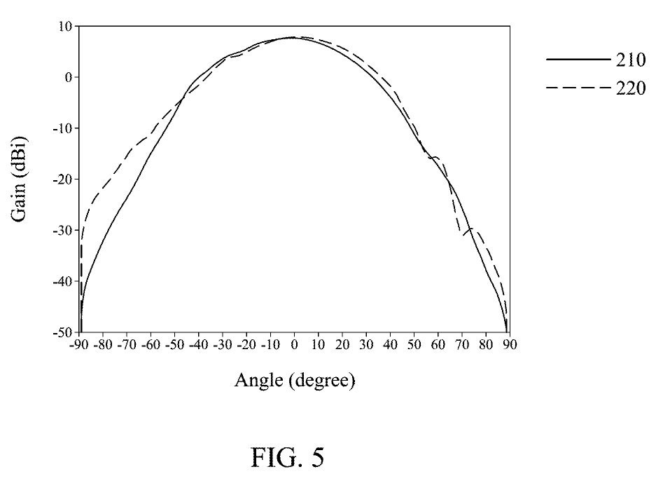

FIG. 5 is a schematic comparison diagram of two-dimensional radiation patterns between the antenna structure 100C of FIG. 4 and that of a comparative example. Referring to FIGS. 4 and 5, the vertical axis represents gain in dBi, and the horizontal axis represents angle in degrees. A solid line 210 indicates the gain of the antenna structure 100C, and a dashed line 220 indicates the gain of the antenna structure of the comparative example. The antenna structure 100C and the antenna structure of the comparative example operate at the same frequency. The antenna structure 100C and the antenna structure of the comparative example are similar. A difference between the two lies in that the antenna structure 100C includes the first ground layer 140; and the distances D1, D2, D3, and D4 between the inner edge 141 of the first ground layer 140 and the antenna structure layer 120 are between one and fifteen times the width W1 of the feed line 130, while the antenna structure of the comparative example does not include the first ground layer 140 surrounding the antenna structure layer 120.

As shown in FIG. 5, compared with the antenna structure of the comparative example, the antenna structure 100C exhibits lower power in a side lobe direction and more concentrated power in a main lobe direction. It can thus be seen that the first ground layer 140 indeed has the effect of enabling the antenna structure 100C to concentrate the directionality of the radiation energy, and also does not affect the operation of the antenna structure 100C. Therefore, through the appropriate distances between the inner edge 141 of the first ground layer 140 and the antenna structure layer 120, the first ground layer 140 does not affect the operation of the antenna structure 100C, and the antenna structure 100C further has the effect of concentrating power in the main lobe direction.

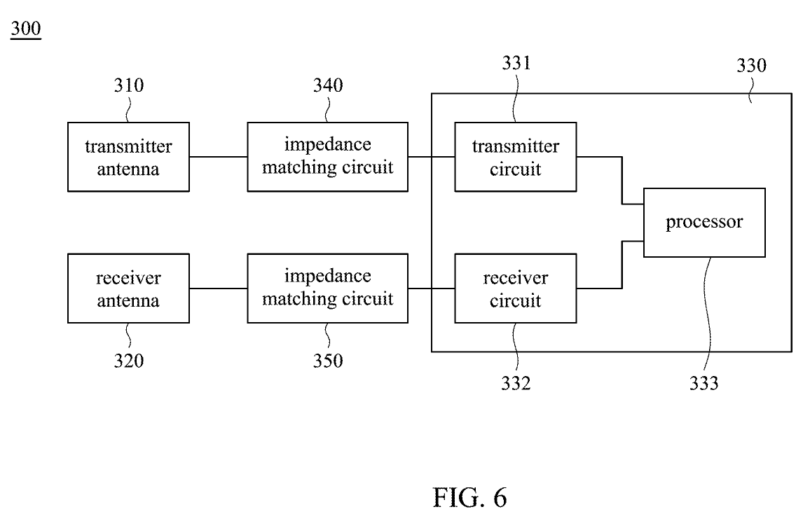

FIG. 6 is a block diagram of an electronic device 300 according to at least one embodiment of the present disclosure. Referring to FIGS. 1, 4 and 6, the electronic device 300 includes a transmitter antenna 310, a receiver antenna 320, a chip 330 and impedance matching circuits 340 and 350. The transmitter antenna 310 is configured to radiate electromagnetic waves. The receiver antenna 320 is configured to receive electromagnetic waves. In particular, the receiver antenna 320 may be the antenna structure according to any of the above embodiments, such as the antenna structure 100A, 100B or 100C. The electronic device 300 may be a radar device for monitoring human physiological information, but is not limited thereto. The electronic device 300 may also be an electronic device applied to other fields.

The chip 330 may include a transmitter circuit 331, a receiver circuit 332, and a processor 333 to control the transmitter antenna 310 and the receiver antenna 320, where the transmitter circuit 331 is electrically connected to the transmitter antenna 310 and the processor 333, and the receiver circuit 332 is electrically connected to the receiver antenna 320 and the processor 333. Thus, the feed line 130 of the antenna structure 100A, 100B, or 100C is electrically connected between the chip 330 and the antenna structure layer 120.

For example, the transmitter circuit 331 may include a power amplifier, a modulator, and an attenuator, and the receiver circuit 332 may include a low noise amplifier (LNA), a demodulator, and an attenuator. The impedance matching circuit 340 may be further electrically connected between the chip 330 and the transmitter antenna 310 to achieve impedance matching between the chip 330 and the transmitter antenna 310. Similarly, the impedance matching circuit 350 may be further electrically connected between the chip 330 and the receiver antenna 320 to achieve impedance matching between the chip 330 and the receiver antenna 320.

During use of the electronic device 300, both the transmitter antenna 310 and the receiver antenna 320 are directed toward a human chest. The electromagnetic waves radiated by the transmitter antenna 310, which is controlled by the chip 330, may directly impinge upon the human chest. The receiver antenna 320 receives the reflected electromagnetic waves, and converts the electromagnetic waves into electrical signals, and transmits the electrical signals to the chip 330. The chip 330 then converts the electrical signals into information related to human physiological information, thereby detecting human physiological parameters. Since the receiver antenna 320 can shield against electromagnetic waves reflected from non-human directions (e.g., reflections from rotating electric fans or fluttering curtains), the electronic device 300 can receive electromagnetic waves actually reflected by the human body, thereby improving the detection accuracy of the electronic device 300.

In summary, the antenna structures 100A, 100B, 100C disclosed in the above embodiments can shield against interference from adjacent circuits or external environments via the first ground layers 140. This enables the antenna structures 100A, 100B, 100C to further concentrate the directionality of the radiation energy, thereby enhancing the signal-to-noise ratio. Furthermore, the first ground layer 140 also does not affect the operation of the antenna structure layer 120. Moreover, the first ground layer 140 may achieve better noise absorption through the conductors 160. Additionally, by using the antenna structures 100A, 100B, 100C as the receiver antenna 320, the electronic device 300 can reduce the impact of noise, thereby enhancing the stability of the electronic device 300.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. An antenna structure, comprising:
a substrate, having a first surface;
an antenna structure layer, disposed on the first surface and having an edge;
a feed line, disposed on the substrate and electrically connected to the antenna structure layer, wherein the feed line has a feed point; and
a first ground layer, disposed on the first surface and having an inner edge, wherein at least part of the antenna structure layer is surrounded by the inner edge, there is a shortest distance between the inner edge and the edge, and the shortest distance is between one and fifteen times a width of the feed line.

2. The antenna structure according to claim 1, wherein the substrate further has a second surface opposite to the first surface;
wherein the antenna structure further comprises:
a second ground layer, disposed on the second surface; and
a plurality of conductors, extending from the first ground layer to the second ground layer and electrically connected to the first ground layer and the second ground layer, wherein the conductors are spaced apart along the inner edge.

3. The antenna structure according to claim 2, wherein a spacing between one of the conductors and the inner edge is less than 1 mm.

4. The antenna structure according to claim 2, wherein a spacing between two adjacent conductors of the conductors is less than 2 mm.

5. The antenna structure according to claim 2, wherein the first ground layer further has an outer edge, wherein the outer edge is farther from the antenna structure layer than the inner edge, the conductors are distributed between the inner edge and the outer edge, and a number of the conductors decreases along a direction extending from the inner edge to the outer edge.

6. The antenna structure according to claim 1, wherein the substrate further has a second surface opposite to the first surface;
wherein the antenna structure further comprises:
a second ground layer, disposed in the substrate and located between the first surface and the second surface; and
a plurality of conductors, extending from the first ground layer to the second ground layer and electrically connected to the first ground layer and the second ground layer, wherein the conductors are spaced apart along the inner edge.

7. The antenna structure according to claim 6, wherein a spacing between one of the conductors and the inner edge is less than 1 mm.

8. The antenna structure according to claim 6, wherein a spacing between two adjacent conductors of the conductors is less than 2 mm.

9. The antenna structure according to claim 6, wherein the first ground layer further has an outer edge, wherein the outer edge is farther from the antenna structure layer than the inner edge, the conductors are distributed between the inner edge and the outer edge, and a number of the conductors decreases along a direction extending from the inner edge to the outer edge.

10. The antenna structure according to claim 1, wherein the first ground layer comprises a plurality of ground strips surrounding the antenna structure layer, each of the ground strips has a width greater than 1 mm.

11. The antenna structure according to claim 10, wherein one of the ground strips has an opening.

12. An antenna structure, comprising:
a substrate, having a first surface;
an antenna structure layer, disposed on the first surface and having an edge;
a feed line, disposed on the substrate and electrically connected to the antenna structure layer, wherein the feed line has a feed point; and
a first ground layer, disposed on the first surface, wherein a plurality of strip-shaped gaps exist between the first ground layer and the edge, the strip-shaped gaps surround the antenna structure layer, and a width of each of the strip-shaped gaps is 1 to 15 times a width of the feed line.

13. The antenna structure according to claim 12, wherein the substrate further has a second surface opposite to the first surface;
wherein the antenna structure further comprises:
a second ground layer, disposed on the second surface; and
a plurality of conductors, extending from the first ground layer to the second ground layer and electrically connected to the first ground layer and the second ground layer, wherein the conductors are spaced apart and surround the strip-shaped gaps.

14. The antenna structure according to claim 13, wherein a spacing between two adjacent conductors of the conductors is less than 2 mm.

15. The antenna structure according to claim 12, wherein the substrate further has a second surface opposite to the first surface;
wherein the antenna structure further comprises:
a second ground layer, disposed in the substrate and located between the first surface and the second surface; and
a plurality of conductors, extending from the first ground layer to the second ground layer and electrically connected to the first ground layer and the second ground layer, wherein the conductors are spaced apart and surround the strip-shaped gaps.

16. The antenna structure according to claim 15, wherein a spacing between two adjacent conductors of the conductors is less than 2 mm.

17. The antenna structure according to claim 12, wherein the first ground layer comprises a plurality of ground strips surrounding the antenna structure layer and the strip-shaped gaps, each of the ground strips has a width greater than 1 mm.

18. The antenna structure according to claim 17, wherein one of the ground strips has an opening.

19. An electronic device, comprising:
an antenna structure comprising:
a substrate, having a first surface;
an antenna structure layer, disposed on the first surface and having an edge;
a feed line, disposed on the substrate, wherein the feed line has a feed point; and
a ground layer, disposed on the first surface and having an inner edge, wherein at least part of the antenna structure layer is surrounded by the inner edge, there is a shortest distance between the inner edge and the edge, and the shortest distance is between one and fifteen times a width of the feed line;
a chip disposed on the substrate, wherein the feed line is electrically connected between the chip and the antenna structure layer; and
a transmitter antenna electrically connected to the chip.

20. The electronic device according to claim 19, wherein a plurality of strip-shaped gaps exist between the inner edge of the ground layer and the edge of the antenna structure layer, the strip-shaped gaps surround the antenna structure layer in a frame-shaped arrangement, and a width of each of the strip-shaped gaps is 1 to 15 times the width of the feed line.
